(19) United States
(12) Patent Application Publication
(10) Pub. No.: US 2011/0134983 A1
(43) Pub. Date: Jun. 9, 2011

(54) METHODS, APPARATUS AND ARTICLES OF MANUFACTURE TO LIMIT DATA RATES OF DIGITAL SUBSCRIBER LINES

(76) Inventors: Arvind Ramdas Mallya, Walnut Creek, CA (US); Orestis Manthoulis, Tiburon, CA (US)

(21) Appl. No.: 12/632,480

(22) Filed: Dec. 7, 2009

(51) Int. Cl. H04B 17/00

(52) U.S. Cl. 375/225

(57) ABSTRACT

Methods apparatus and articles of manufacture to limit data rates of digital subscriber lines are disclosed. An example method comprises monitoring during a first time interval data usage of a digital subscriber line, determining based on the data usage whether to limit a data rate associated with the digital subscriber line during a second time interval subsequent to the first time interval, and when the data rate is to be limited during the second time interval disabling one or more transmission frequencies of the digital subscriber line.

### FIELD OF THE DISCLOSURE

This disclosure relates generally to digital subscriber lines and, more particularly, to methods, apparatus and articles of manufacture to limit data rates of digital subscriber lines.

### BACKGROUND

Communication systems using twisted-pair copper wire technologies such as digital subscriber line (DSL) technologies are commonly utilized to provide Internet-related services to subscribers such as homes and/or businesses (also referred to herein collectively and/or individually as users, customers and/or customer premises). For example, a communication company and/or service provider may utilize a plurality of DSL modems implemented at a central location (e.g., a central office, a vault, a remote terminal, etc.) to provide communication services to a plurality of residential gateways (RGs) located at respective customer premises. In general, a central-site modem receives broadband service content from, for example, a backbone server and forms downstream signals to be transmitted to respective customer-premises RGs. Each RG may subsequently deliver all or any portion(s) of a received downstream signal to respective customer-premises devices associated with the RG. Likewise, the central-site modem receives an upstream signal from each of the RGs and/or customer-premises devices associated with the RGs and provides the data transported in the upstream signal to the backbone server.

### BRIEF DESCRIPTION OF THE DRAWINGS

FIG. 1 is a schematic illustration of an example DSL communication system constructed in accordance with the teachings of this disclosure.

FIG. 2 illustrates an example manner of implementing the example monitors of FIG. 1.

FIG. 3 is a flowchart representative of an example process that may be carried out by, for example, a processor to implement the example monitors of FIGS. 1 and 2.

FIG. 4 is a schematic illustration of an example processor platform that may be used and/or programmed to execute the example process of FIG. 3 and/or to implement any or all of the disclosed examples.

### DETAILED DESCRIPTION

Methods, apparatus and articles of manufacture to limit data rates of digital subscriber lines are disclosed. A disclosed example method includes monitoring during a first time interval data usage of a digital subscriber line, determining based on the data usage whether to limit a data rate associated with the digital subscriber line during a second time interval subsequent to the first time interval, and when the data rate is to be limited during the second time interval disabling one or more transmission frequencies of the digital subscriber line.

A disclosed example apparatus includes a usage monitor to obtain during a first time interval data usage information of a digital subscriber line, a data rate limiter to determine based on the data usage information whether to limit a data rate associated with the digital subscriber line during a second time interval subsequent to the first time interval, and a frequency bandwidth selector to disable one or more transmission frequencies of the digital subscriber line when the data rate is to be limited during the second time interval.

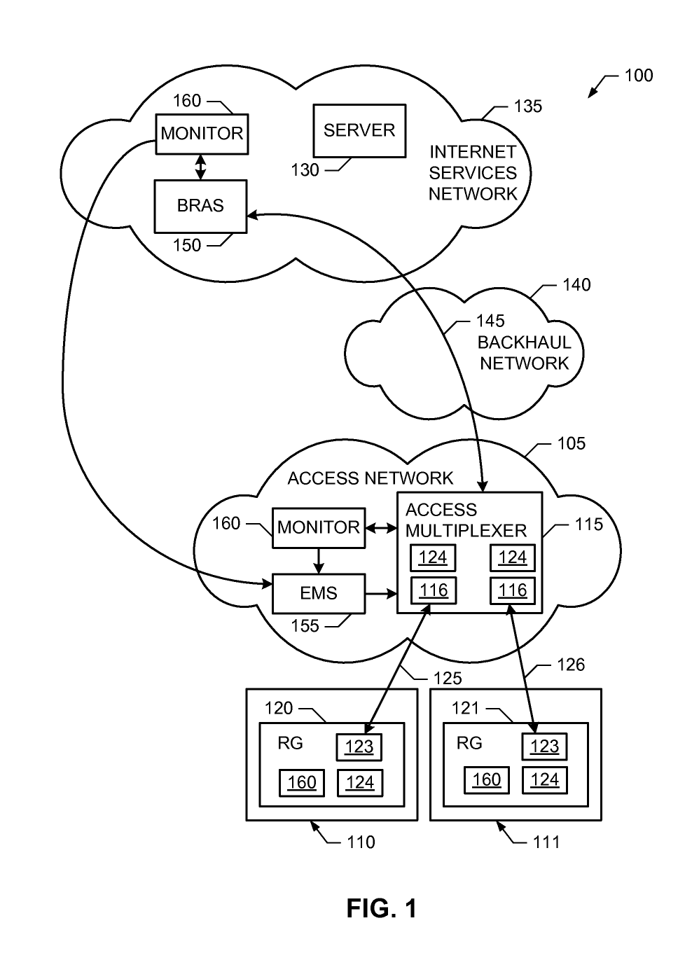

FIG. 1 illustrates an example DSL communication system 100 including an access network 105 that provides data and/or communication services (e.g., telephone services, Internet services, data services, messaging services, instant messaging services, electronic mail (email) services, chat services, video services, audio services, gaming services, etc.) to one or more customer premises, two of which are designated at reference numerals 110 and 111. To provide DSL communication services to the example customer premises 110 and 111, the example access network 105 of FIG. 1 includes any number and/or type(s) of access multiplexers, one of which is designated at reference numeral 115, and the example customer premises 110 and 111 include any type(s) of residential gateways (RGs) 120 and 121. Example access multiplexers 115 include, but are not limited to, a DSL access multiplexer (DSLAM) and/or a video ready access device (VRAD). The example access multiplexer 115 of FIG. 1 includes and/or implements central office (CO) DSL modems 116 for respective ones of the customer-premises locations 110 and 111. The example RGs 120 and 121 of FIG. 1 implement respective customer-premises equipment (CPE) DSL modems 123 that communicate with respective ones of the CO DSL modems 116. The example access multiplexer 115 of FIG. 1 enables the example RGs 120 and 121 to communicate with remote devices and/or servers (e.g., a server 130 of an example service network 135).

In the illustrated example of FIG. 1, the access multiplexer 115 provides DSL services to the RGs 120 and 121 via respective digital subscriber lines 125 and 126. Digital subscriber lines are sometimes also referred to in the industry as “subscriber lines,” “wire-pairs,” “subscriber loops” and/or “loops.” A digital subscriber line (e.g., any of the example digital subscriber lines 125 and 126) used to provide a DSL service to a customer-premises location (e.g., any of the locations 110 and 111) may include and/or be constructed from one or more segments of twisted-pair telephone wire (e.g., a combination of a feeder one (F1) cable, a distribution cable, a drop cable, and/or customer-premises wiring), terminals and/or distributions points (e.g., a serving area interface (SAI), a serving terminal, a vault and/or a pedestal). Such segments of twisted-pair telephone wire may be spliced and/or connected end-to-end, and/or may be connected at only one end thereby creating one or more bridged-taps. Regardless of the number, type(s), gauge(s) and/or topology of twisted-pair telephone wires used to construct the example digital subscriber lines 125 and 126, these lines will be referred to herein in the singular form, but it will be understood that the term “digital subscriber line” may refer to one or more twisted-pair telephone wire segments and may include one or more bridged taps.

The example access multiplexer 115, the example CO DSL modems 116, the example RGs 120 and 121 and/or the example CPE DSL modems 123 may be implemented, for example, in accordance with the International Telecommunications Union-Telecommunications Sector (ITU-T) G.993.x family of standards for very high-speed DSL (VDSL) and/or the ITU-T G.992.x family of standards for asymmetric DSL (ADSL). As defined by the G.992.x and G.993.x families of standards, the example DSL modems 116 and 123 adaptively communicate over the example digital subscriber lines 125 and 125 using a plurality of coordinated transmission frequencies, carriers and/or tones that operate in parallel to transport data over the digital subscriber lines 125 and 126 at high data rates. The achievable data rate for each of the digital subscriber lines 125, 126 depends on the number of configured, allowable and/or useable transmission frequencies, the attenuation of the digital subscriber line 125, 126 at those frequencies, and the noise present on the digital subscriber line 125, 126 at those frequencies. The allowable transmission frequencies, carriers and/or tones are defined for each of the DSL modems 116, 123 via a respective tone mask table 124. The example tone mask tables 124 of FIG. 1 define and/or identify the transmission frequencies, carriers and/or tones that may be used for communicating via a respective digital subscriber line 125, 126. The example tone mask tables 124 define masks, gains or attenuations to be applied to respective transmission frequencies, carriers and/or tones during modem initialization and/or data transmission. For example, by setting the gain associated with a particular transmission frequency to zero in a particular tone mask table 124, that transmission frequency is disabled and/or masked from use by the associated DSL modem 116, 123. In general, the more transmission frequencies, carriers and/or tones that are enabled for use, the higher the data rate obtainable on the respective digital subscriber line 125, 126. The example tone mask tables 124 may define and/or identify transmission frequencies, carriers and/or tones for both downstream data transport from the access multiplexer 115 toward the RGs 120 and 121 and upstream data transport from the RGs 120 and 121 toward the access multiplexer 115.

To transport data to and/or from the example access multiplexer 115, the example communication system 100 of FIG. 1 includes a backhaul network 140 and a respective communication path 145 through the backhaul network 140. The example backhaul network 140 and the example communication path 145 of FIG. 1 communicatively couple the example access multiplexer 115 to the example server 130, and/or any number and/or type(s) of access servers such as a broadband remote access server (BRAS) 150.

The example BRAS 150 of FIG. 1 controls and/or limits access of the RGs 120 and 121 to any number and/or type(s) of public and/or private service networks, such as the example Internet services network 135. For example, the BRAS 150 may verify the identity of a user and/or a particular RG 120, 121 before the user and/or the RG 120, 121 is allowed to access data and/or communication services implemented by and/or provided via the example service network 135.

To configure the example access network 105, the example communication system 100 of FIG. 1 includes an element management system (EMS) 155. The example EMS 155 of FIG. 1, among other things, configures the example RGs 120 and 121, the example DSL modems 116 and 123 and/or the example access multiplexer 115 with one or more profiles, parameters and/or settings that enable the RGs 120 and 121 to access the Internet services network 135 and/or other communication services offered by a service provider (e.g., telephone services, data services, messaging services, instant messaging services, electronic mail (email) services, chat services, video services, television services, audio services, gaming services, etc.).

The example communication path 145 and/or the backhaul network 140 of FIG. 1 are implemented by any number and/or type(s) of past, current and/or future communication network(s), communication system(s), communication device(s), transmission medium(s), protocol(s), technique(s), specification(s) and/or standard(s). For example, the access multiplexer 115 may be coupled to the BRAS 150 via any type(s) of Ethernet transceiver(s), optical transceiver(s) and/or ATM transceiver(s) implemented by and/or within the example access multiplexer 115, the example communication path 145 and/or the example backhaul network 140. The example communication path 145 of FIG. 1 may be a direct and/or an indirect communication path between the access multiplexer 115 and the BRAS 150. For example, the example communication path 145 may be implemented as any number and/or type(s) communicatively coupled segments, and/or may pass through any number and/or type(s) of Layer 2 Tunnel Protocol (L2TP) access concentrator(s) (LAC(s), switch(s), router(s), and/or optical coupling device(s).

The example communication path 145 of FIG. 1 may have a limited bandwidth, transmission rate and/or data rate that may be used by the access multiplexer 115 to exchange data with the BRAS 150 and/or, more generally, the example Internet services network 135. The example communication path 145 of FIG. 1 carries and/or transports data for a plurality of RGs 120 and 121. Thus, as the number of RGs 120 and 121 connected to and/or transmitting data to and/or from an access multiplexer 115 increases, and/or as the amount and/or speed of data transmitted by any of the RGs 120 and 121 increases, the loading and/or utilization of the communication path 145 associated with the access multiplexer 115 increases. Traditionally, the data rate associated with a particular RG 120, 121 is defined by a service profile assigned to that RG 120, 121 when DSL service is installed, provisioned and/or changed. However, a conventional service profile does not include parameters that adjust and/or select data rates for their associated digital subscriber line 125, 126 based on data usage patterns of the user(s) associated with the service profile. Accordingly, even though a service provider may assume that a group of users will on average only utilize 20% of their digital subscriber line's configured data rate, it is possible that any subset of the users could sustain much higher data rates over long periods of time. Such circumstances may result in bandwidth demands on the communication path 145 that exceed the transmission capability of the communication path 145 and/or any queues associated with the communication path 145 and/or the access multiplexer 115. Additionally or alternatively, some users may initiate excessive numbers of communication sessions via their digital subscriber line 125, 126. Such excessive numbers of communication sessions may also place undue demands on the access multiplexer 115, the backhaul network 140 and/or the Internet services network 135.

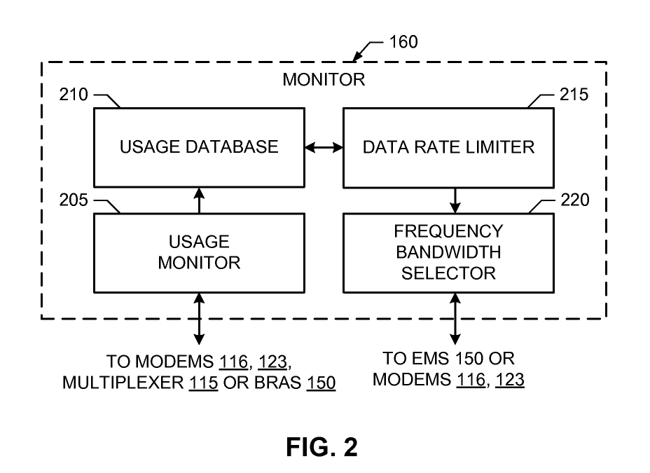

To control, select and/or limit data rates associated with the example digital subscriber lines 125 and 126, the example communication system 100 of FIG. 1 includes one or more monitors 160. As shown in FIG. 1, the example monitors 160 may be implemented by the example Internet services network 135, by the example access network 105 and/or by the example RGs 120 and 121. While the same monitor 160 is depicted as implemented at different locations within the example communication system 100, a monitor 160 need not be implemented at each depicted location. Further, while the example monitors 160 are all designated with the same reference numeral in FIG. 1, it should be understood that they may differ in how they collect data usage information and/or how they affect data rate limits for the digital subscriber lines 125 and 126. However, because all of the example monitors 160 of FIG. 1 monitor data usage of digital subscriber lines and limit date rates of digital subscriber lines by adjusting the number of transmission frequencies, carriers and/or tones they are all designated using the same reference numeral 160 to reflect their common functionality. An example manner of implementing the example monitors 160 is described below in connection with FIG. 2.

The example monitors 160 of FIG. 1 collect, for one or more digital subscriber lines 125 and 126, data usage information such as a number of active communication sessions and/or an amount of data transported per time period. The amount of transported data per time interval may be measured in any number and/or type(s) of units such as bytes, ATM cells, IP packets, etc. Based on the collected data usage information, the example monitor 160 determines whether the data rate associated with a particular digital subscriber line 125, 126 should be limited, restricted and/or otherwise reduced to ensure that the digital subscriber line 125, 126 does not or can no longer exceed the usage limits of its associated service agreement. If a particular digital subscriber line 125, 126 is to have its bandwidth limited, the example monitor 160 re-configures and/or adjusts one or more of the tone mask tables 124 associated with that digital subscriber line 125, 126 to reduce the number of transmission frequencies, carriers and/or tones available for transporting data via the digital subscriber line 125, 126. The number of allowable transmission frequencies, carriers and/or tones may be re-configured and/or adjusted by directing and/or instructing the EMS 155 to make the corresponding changes to the tone mask table 124 and/or by directly modifying the tone mask table 124. In some examples, the EMS 155 modifies the tone mask tables 124 implemented at the RGs 120 and 121 to limit digital subscriber line data rates. When a particular tone mask table 124 is modified, the associated example DSL modems 116 and 123 automatically and dynamically adjust and/or rate adapt their transmissions as defined in the G.992.x and G.993.x families of standards. During such adjustments and/or adaptations some transmission errors may occur. However, the implementation of suitable error correction protocols and/or data retransmission protocols such as those inherent to the G.992.x and G.993.x families of standards and/or inherent to IP transmissions should substantially prevent such errors from being user perceptible.

The transmission frequencies, carriers and/or tones to be disabled may be selected using any number and/or type(s) of method(s) and/or algorithm(s). For example, the highest frequency carriers and/or tones may be disabled first, the frequencies, carriers and/or tones transporting the most data may be disabled first, etc. In some examples, whether a digital subscriber line 125, 126 has its data rate limited is determined by comparing its average amount of transported data per time interval to a threshold and/or by comparing its number of active communication sessions to another threshold. The thresholds may depend on the service level agreement associated with the digital subscriber line 125, 126, may depend on the data usage of other digital subscriber lines 125, 126, and/or may depend on time of day. For example, the thresholds may be decreased to limit the data rate of all of the digital subscriber lines 125 and 126 during high usage periods of time, and/or may be increased during off-peak periods of time (e.g., at 2:00 AM).

When data usage falls below the threshold(s), the disabled transmission frequencies, carriers and/or tones may be re-enabled. In some examples, the data usage may have to remain below the threshold(s) for a specified period of time before the transmission frequencies, carriers and/or tones are re-enabled. Data usage may be monitored and data rates may be restricted independently for upstream and downstream communication directions. For example, a downstream data rate may be restricted and/or limited while an upstream data rate remains unlimited. Moreover, downstream and upstream data rates need not be the same.

In the illustrated example communication system 100 of FIG. 1, the example access network 105, the example access multiplexer 115, the example backhaul network 140, the example communication path 145, the example BRAS 150, the example server 130, the example Internet services network 135, and the example monitors 160 are owned and/or operated by a single service provider. That is, the service provider owns, operates, utilizes, implements and/or configures the example access network 105, the example access multiplexer 115, the example backhaul network 140, the example communication path 145, the example BRAS 150, the example server 130, the example Internet services network 135, and the example monitors 160 to provide data and/or communication services across any type(s) and/or size(s) of geographic area(s). Persons of ordinary skill in the art will readily recognize that any of the example access network 105, the example access multiplexer 115, the example backhaul network 140, the example communication path 145, the example BRAS 150, the example server 130, the example Internet services network 135, and the example monitors 160 may be owned and/or operated by a different service provider. For example, a first service provider may own and/or operate the backhaul network 140, while a second service provider owns and/or operates the access multiplexer 115, the BRAS 150 and/or the Internet services network 135. The example RGs 120 and 121 of FIG. 1 may be customer owned, may be leased and/or rented by a customer from a service provider, and/or may be owned by the service provider.

While an example communication system 100 has been illustrated in FIG. 1, the elements illustrated in FIG. 1 may be combined, divided, re-arranged, eliminated and/or implemented in any way. Further, the example RGs 120 and 121, the example DSL modems 116 and 123, the example access multiplexer 115, the example EMS 155, the example BRAS 150, the example monitors 160 and/or, more generally, the example communication system 100 of FIG. 1 may be implemented by hardware, software, firmware and/or any combination of hardware, software and/or firmware. Thus, for example, any of the example RGs 120 and 121, the example DSL modems 116 and 123, the example access multiplexer 115, the example EMS 155, the example BRAS 150, the example monitors 160 and/or, more generally, the example communication system 100 may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the example RGs 120 and 121, the example DSL modems 116 and 123, the example access multiplexer 115, the example EMS 155, the example BRAS 150, the example monitors 160 and/or, more generally, the example communication system 100 are hereby expressly defined to include a tangible medium such as a memory, a digital versatile disc (DVD), a compact disc (CD), etc. storing the software and/or firmware. Further still, the example communication system 100 may include additional devices, servers, systems, networks and/or processors in addition to, or instead of, those illustrated in FIG. 1, and/or may include more than one of any or all of the illustrated devices, servers, networks, systems and/or processors.

FIG. 2 illustrates an example manner of implementing the example monitors 160 of FIG. 1. To collect data usage information, the example monitor 160 of FIG. 2 includes a usage monitor 205. Using any number and/or type(s) of method(s), protocol(s), message(s), application programming interface(s) (API(s)), the example usage monitor 205 of FIG. 2 interacts with the example DSL modems 116, 123, the example access multiplexer 115 and/or the example BRAS 150 to collect, retrieve and/or otherwise obtain data usage information for upstream and downstream directions of one or more digital subscriber lines 125 and 126. For example, the usage monitor 205 may utilize an API to access internal registers to obtain the number of bytes transported, number of ATM cells transported, number of IP packets transported, the number of open communication sessions, etc.

The example usage monitor stores the collected data usage information in a usage database 210 using any number and/or type(s) of data structure(s) and/or record(s). The example usage database 210 of FIG. 2 may be implemented by any number and/or type(s) of tangible memory(-ies), memory device(s) and/or storage device(s).

To determine whether to limit the data rate of a particular digital subscriber line 125, 126, the example monitor 160 of FIG. 2 includes a data rate limiter 215. The example data rate limiter 215 of FIG. 2 compares one or more values representative of data usage to respective thresholds to determine whether to limit the data rate of the digital subscriber line 125, 126. In some examples, the example data rate limiter 215 determines whether to data rate limit a particular digital subscriber line 125, 126 by comparing its average amount of transported data per time interval to a threshold and/or by comparing its number of active communication sessions to another threshold. The threshold(s) may depend on the service level agreement associated with the digital subscriber line 125, 126, may depend on the data usage of other digital subscriber lines 125, 126, and/or may depend on time of day. For example, the thresholds may be decreased to limit the data rate of all of the digital subscriber lines 125 and 126 during high usage periods of time, and/or may be increased during off-peak periods of time (e.g., at 2:00 AM).

When data usage falls below the threshold(s), the example data rate limiter 215 of FIG. 2 re-enables the disabled transmission frequencies, carriers and/or tones. In some examples, the data usage may have to remain below the threshold(s) for a specified period of time before the transmission frequencies, carriers and/or tones are re-enabled. The example data rate limiter 215 may independently monitor data usage for the upstream and downstream communication directions. For example, a downstream data rate may be restricted and/or limited while an upstream data rate remains unlimited.

To select which transmission frequencies, carriers and/or tones are to be disabled, the example monitor 160 of FIG. 2 includes a frequency bandwidth selector 220. When the example data rate limiter 215 determines that a particular digital subscriber line 125, 126 is to have its data rate limited, the example frequency bandwidth selector 220 of FIG. 2 identifies which transmission frequencies, carriers and/or tones to disable. The example frequency bandwidth selector 220 may use any number and/or type(s) of method(s) and/or algorithm(s) to determine which transmission frequencies, carriers and/or tones to disable. For example, the highest frequency carriers and/or tones may be disabled first, the frequencies, carriers and/or tones transporting the most data may be disabled first, etc. The example frequency bandwidth selector 220 modifies the tone mask table 124 for the digital subscriber line 125, 126 either directly and/or via the EMS 155.

When the example data rate limiter 215 determines that a particular digital subscriber line 125, 126 is no longer to be data rate limited, the example frequency bandwidth selector 220 modifies the tone mask table 124 for the digital subscriber line 125, 126 to re-enable previously disable transmission frequencies, carriers and/or tones.

While an example manner of implementing the example monitors 160 of FIG. 1 has been illustrated in FIG. 2, the interfaces, modules, elements and/or devices illustrated in FIG. 2 may be combined, divided, re-arranged, eliminated and/or implemented in any way. Further, the example usage monitor 205, the example usage database 210, the example data rate limiter 215, the example frequency bandwidth selector 220 and/or, more generally, the example monitor 160 of FIG. 2 may be implemented by hardware, software, firmware and/or any combination of hardware, software and/or firmware. Thus, for example, any of the example usage monitor 205, the example usage database 210, the example data rate limiter 215, the example frequency bandwidth selector 220 and/or, more generally, the example monitor 160 may be implemented by one or more circuit(s), programmable processor(s), ASIC(s), PLD(s) and/or FPLD(s), etc. When any of the appended apparatus claims are read to cover a purely software and/or firmware implementation, at least one of the example usage monitor 205, the example usage database 210, the example data rate limiter 215, the example frequency bandwidth selector 220 and/or, more generally, the example monitor 160 are hereby expressly defined to include a tangible medium such as a memory, a DVD, a CD, etc. storing the software and/or firmware. Further still, the example monitor 160 may include additional interfaces, modules, elements and/or devices in addition to, or instead of, those illustrated in FIG. 2, and/or may include more than one of any or all of the illustrated interfaces, modules, elements and/or devices.

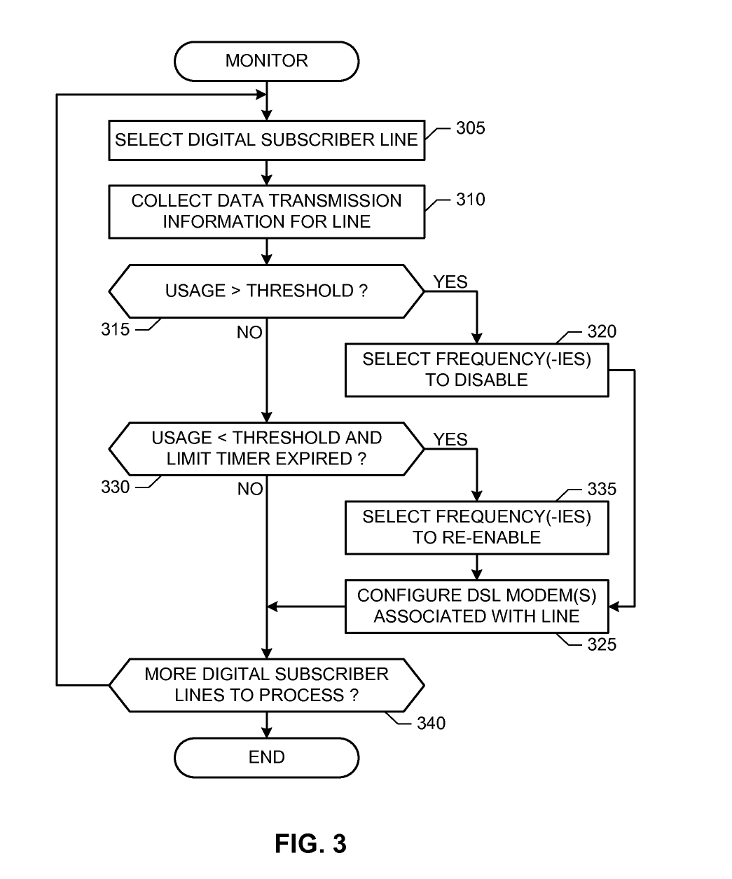

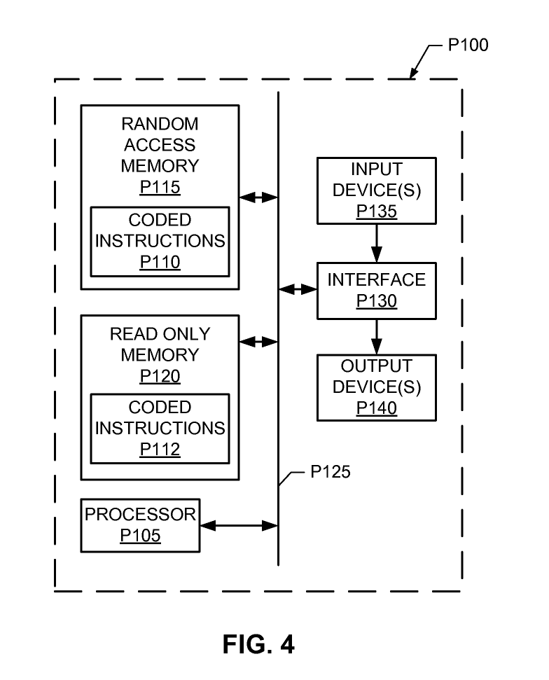

FIG. 3 is a flowchart representative of an example process that may be carried out to implement the example monitors 160 of FIGS. 1 and 2. The example process of FIG. 3 may be carried out by a processor, a controller and/or any other suitable processing device. For example, the process of FIG. 3 may be embodied in coded instructions stored on any article of manufacture, such as any tangible computer-readable medium. Example tangible computer-readable media include, but are not limited to, a flash memory, a CD, a DVD, a floppy disk, a read-only memory (ROM), a random-access memory (RAM), a programmable ROM (PROM), an electronically-programmable ROM (EPROM), and/or an electronically-erasable PROM (EEPROM), an optical storage disk, an optical storage device, magnetic storage disk, a magnetic storage device, and/or any other medium which can be used to carry or store program code and/or instructions in the form of machine-accessible instructions or data structures, and which can be electronically accessed by a processor, a general-purpose or special-purpose computer, or other machine with a processor (e.g., the example processor platform P100 discussed below in connection with FIG. 4). Combinations of the above are also included within the scope of computer-readable media. Machine-accessible instructions comprise, for example, instructions and/or data that cause a processor, a general-purpose computer, special-purpose computer, or a special-purpose processing machine to implement one or more particular processes. Alternatively, some or all of the example process of FIG. 3 may be implemented using any combination(s) of ASIC(s), PLD(s), FPLD(s), discrete logic, hardware, firmware, etc. Also, some or all of the example process of FIG. 3 may instead be implemented manually or as any combination of any of the foregoing techniques, for example, any combination of firmware, software, discrete logic and/or hardware. Further, many other methods of implementing the example operations of FIG. 3 may be employed. For example, the order of execution of the blocks may be changed, and/or one or more of the blocks described may be changed, eliminated, sub-divided, or combined. Additionally, any or all of the example process of FIG. 3 may be carried out sequentially and/or carried out in parallel by, for example, separate processing threads, processors, devices, discrete logic, circuits, etc.

The example process of FIG. 3 begins with the example data rate limiter 215 selecting a particular digital subscriber line 125, 126 to analyze (block 305). The example usage monitor 205 collects, retrieves and/or otherwise obtains data usage information for a first time interval for the selected digital subscriber line 125, 126 (block 310). If the example data rate limiter 215 determines that one or more data usage values are greater than a respective threshold (block 315), the example frequency bandwidth selector 220 selects one or more transmission frequencies, carriers and/or tones to be disabled (block 320). The frequency bandwidth selector 220 makes corresponding modifications to the tone mask table(s) 124 of the DSL modem(s) associated with the digital subscriber line 125, 126 to affect data rate limiting during a subsequent time period (block 325).

Returning to block 315, if the data rate limiter 215 does not determine that the digital subscriber line 125, 126 is to be data rate limited (block 315), the data rate limiter 215 determines whether a previous data rate limit can be unapplied (block 330). For example, the data rate limiter 315 can determine that data usage values have been below their respective thresholds until a timer expires. If a previously applied data rate limit is to be removed (block 330), the frequency bandwidth selector 220 makes corresponding modifications to the tone mask table(s) 124 of the DSL modem(s) associated with the digital subscriber line 125, 126 to re-enable previously disabled transmission frequencies, carriers and/or tones during a subsequent time period (block 325).

If there are more digital subscriber lines to process (block 340), control returns to block 305 to select the next digital subscriber line. Otherwise, control exits from the example process of FIG. 3.

FIG. 4 is a schematic diagram of an example processor platform P100 that may be used and/or programmed to implement the example monitors 160 of FIGS. 1 and 2. For example, the processor platform P100 can be implemented by one or more general-purpose processors, processor cores, microcontrollers, etc.

The processor platform P100 of the example of FIG. 4 includes at least one general purpose programmable processor P105. The processor P105 executes coded and/or machine-accessible instructions P110 and/or P112 stored in main memory of the processor P105 (e.g., within a RAM P115 and/or a ROM P120). The processor P105 may be any type of processing unit, such as a processor core, a processor and/or a microcontroller. The processor P105 may execute, among other things, the example process of FIG. 3 to implement the example methods, apparatus and articles of manufacture described herein.

The processor P105 is in communication with the main memory (including a ROM P120 and/or the RAM P115) via a bus P125. The RAM P115 may be implemented by DRAM, SDRAM, and/or any other type of RAM device, and ROM may be implemented by flash memory and/or any other desired type of memory device. Access to the memory P115 and the memory P120 may be controlled by a memory controller (not shown).

The processor platform P100 also includes an interface circuit P125. The interface circuit P125 may be implemented by any type of interface standard, such as an external memory interface, serial port, general-purpose input/output, etc. One or more input devices P130 and one or more output devices P140 are connected to the interface circuit P125. The input devices P130 and/or output devices P140 may be used to, for example, collect, retrieve and/or otherwise obtain data usage information, and/or the output devices P140 may be used to, for example, modify the example tone mask tables 124.

While for clarity of illustration and explanation, example methods, apparatus and articles of manufacture are described herein with reference to communication systems implemented using digital subscriber line (DSL) technologies to transport data to and/or from customer premises. However, the examples disclosed herein may, additionally or alternatively, be used to limit data rates for any number and/or type(s) of other communication technology(-ies) and/or protocol(s). Other example technologies and/or protocols include, but are not limited to, those associated with public switched telephone network (PSTN) systems, public land mobile network (PLMN) systems (e.g., cellular), wireless distribution systems, Institute of Electrical and Electronics Engineers (IEEE) 802.16 based distribution systems (a.k.a. WiMAX), wired distribution systems, coaxial cable distribution systems, Ultra High Frequency (UHF)/Very High Frequency (VHF) radio frequency systems, satellite or other extra-terrestrial systems, cellular distribution systems, power-line broadcast systems, fiber optic networks, passive optical network (PON) systems, and/or any combination and/or hybrid of these devices, systems and/or networks.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
monitoring during a first time interval data usage of a digital subscriber line;
determining based on the data usage whether to limit a data rate associated with the digital subscriber line during a second time interval subsequent to the first time interval; and
when the data rate is to be limited during the second time interval disabling one or more transmission frequencies of the digital subscriber line.

2. A method as defined in claim 1, further comprising selecting higher frequency carriers as the one or more transmission frequencies to be disabled.

3. A method as defined in claim 1, wherein disabling the one or more transmission frequencies of the digital subscriber line comprises directing an element management system to configure a digital subscriber line modem associated with the digital subscriber line.

4. A method as defined in claim 1, wherein disabling the one or more transmission frequencies of the digital subscriber line comprises selecting gain values for respective ones of the one or more transmission frequencies.

5. A method as defined in claim 1, wherein disabling the one or more transmission frequencies of the digital subscriber line comprises instructing a digital subscriber line modem at a remote end of the digital subscriber line to disable the one or more transmission frequencies.

6. A method as defined in claim 1, wherein determining based on the data usage whether to limit the data rate comprises comparing the data usage to a threshold.

7. A method as defined in claim 6, wherein the threshold is selected based on a second data usage associated with a second digital subscriber line.

8. A method as defined in claim 6, wherein the threshold is selected based on a time of day.

9. A method as defined in claim 1, wherein the data usage represents a number or communication sessions transported via the digital subscriber line.

10. A method as defined in claim 1, wherein the data usage represents a number of bytes transported via the digital subscriber line during the first time interval.

11. An article of manufacture storing machine readable instructions which, when executed, cause a machine to:
monitor during a first time interval data usage of a digital subscriber line;
determine based on the data usage whether to limit a data rate associated with the digital subscriber line during a second time interval subsequent to the first time interval; and
when the data rate is to be limited during the second time interval disable one or more transmission frequencies of the digital subscriber line.

12. An article of manufacture as defined in claim 11, wherein the machine readable instructions, when executed, cause the machine to compare the data usage information to a threshold to determine whether to limit the data rate.

13. An article of manufacture as defined in claim 12, wherein the machine readable instructions, when executed, cause the machine to select the threshold based on at least one of a time of day or a second data usage associated with a second digital subscriber line

14. An article of manufacture as defined in claim 11, wherein the data usage represents at least one of a number or communication sessions transported via the digital subscriber line or a number of bytes transported via the digital subscriber line during the first time interval

15. An apparatus comprising:
a usage monitor to obtain during a first time interval data usage information of a digital subscriber line;
a data rate limiter to determine based on the data usage information whether to limit a data rate associated with the digital subscriber line during a second time interval subsequent to the first time interval; and
a frequency bandwidth selector to disable one or more transmission frequencies of the digital subscriber line when the data rate is to be limited during the second time interval.

16. An apparatus as defined in claim 15, wherein the data rate limiter is to compare the data usage information to a threshold to determine whether to limit the data rate.

17. An apparatus as defined in claim 16, wherein the data rate limiter is to select the threshold based on at least one of a time of day or a second data usage associated with a second digital subscriber line.

18. An apparatus as defined in claim 15, wherein the data usage represents at least one of a number or communication sessions transported via the digital subscriber line or a number of bytes transported via the digital subscriber line during the first time interval.
